(19) United States
(12) Patent Application Publication
(10) Pub. No.: US 2007/0063942 A1
(43) Pub. Date: Mar. 22, 2007

(54) Liquid crystal display drive and control device, crystal display panel module and mobile terminal system

(75) Inventor: Keiichi Itoigawa, Tokyo (JP)

Correspondence Address: MILES & STOCKBRIDGE PC, 1751 PINNACLE DRIVE, SUITE 500, MCLEAN, VA, 22102-3833, US

(73) Assignee: Renesas Technology Corp.

(21) Appl. No.: 11/501,104

(22) Filed: Aug. 9, 2006

(30) Foreign Application Priority Data
Sep. 16, 2005 (JP) 2005-269709

(51) Int. Cl. G09G 3/36

(52) U.S. Cl. 345/87

(57) ABSTRACT

A liquid crystal drive controller comprises first lines drawn from the input terminals of a strobing comparator, first external terminals capable of connecting the first lines to strobing transmission lines, second lines drawn from a strobing offset current source, and second external terminals capable of connecting the second lines to the strobing transmission lines. The first lines and the first external terminals, and the second lines and the second external terminals are electrically insulated from each other on the liquid crystal drive controller. First wires and second wires are connected to strobing terminals so that the first wires are not included in the strobing offset current path, thereby eliminating a shortage of margin.

### CROSS-REFERENCE TO RELATED APPLICATION

The present application claims priority from Japanese patent application No 2005-269709 filed on Sep. 16, 2005, the content of which is hereby incorporated by reference into this application.

### BACKGROUND OF THE INVENTION

The present invention relates to a liquid crystal drive controller, a liquid crystal panel module and a portable terminal system comprising the same and, specifically, to a technology effectively applied to a portable telephone.

A portable telephone which is an example of a portable terminal system comprises a high-frequency interface unit, a base band unit, a liquid crystal drive controller, a liquid crystal display, a microphone and a speaker. When a folding structure is adopted in a housing incorporating these circuits, a pair of housings are combined together in such a manner that they can be opened and closed by hinges. When the liquid crystal drive controller and the liquid crystal display are installed in one of the housings, the base band unit for providing a display command and display data to the liquid crystal drive controller is installed in the other housing together with the high-frequency interface unit in most cases. When the baseband unit and the liquid crystal drive controller are installed in different housings, a large number of signal lines for connecting them pass through the hinges.

The number of wires for connecting the above base band unit and the liquid crystal drive controller tends to increase as the liquid crystal display driven by the liquid crystal drive controller has higher definition and displays more colors. Further, when peripheral devices such as a sub-display constituting a monitor screen for dynamic pictures and still pictures, a camera flash light and LED for illumination display are installed in the same housing as the liquid crystal display due to an increase in the number of functions of the portable telephone, the number of interface signal lines for controlling them increases. As described in patent document 1, display data and commands are supplied to the liquid crystal drive controller of the prior art from the base band unit over parallel buses. Packets having a predetermined format are used to supply data and commands in most cases. Not only packets disclosed by patent document 2 but also packets having various formats are used for the above purpose.

[patent document 1] JP-A 2001-222276

[patent document 2] JP-T 2004-531916

### SUMMARY OF THE INVENTION

A liquid crystal panel module comprises a liquid crystal drive controller on a transparent substrate such as a glass substrate on which a liquid crystal display unit (liquid crystal display) capable of displaying information is formed. When this liquid crystal panel module is used, serial transmission based on VESA standards has begun to be used in order to reduce the number of wires as a logic signal transmission technology between the base band unit and the liquid crystal drive controller on the glass substrate. The inventors of the present invention have studied serial transmission based on VESA standards as shown in FIG. 5. The base band unit 4 and the liquid crystal drive controller 10 are connected to each other by serial transmission lines based on VESA standards. The liquid crystal drive controller 10 comprises a host interface circuit 20 which includes a strobing comparator 51, a data comparator 52, a data output buffer 53 and an offset power source 54. A strobing signal is transmitted from the base band unit 4 to the liquid crystal drive controller 10 and a data signal is transmitted in both directions between them. When a comparator activation signal CMP-ST is changed from a low level to a high level by the base band unit 4, the strobing comparator 51 and the data comparator 52 are activated. A current is differentially output from the base band unit 4, and the strobing comparator 51 detects a logic level (high level or low level) from a potential difference generated in a load resistor RL1 provided in the transmission line to carry out signal transmission. When a stand-by mode is shifted to an ordinary operational mode in this constitution, to prevent erroneous operation which occurs when a noise is superimposed on a strobing signal STR, a strobing offset current “lof” is applied to the load resistor RL1 by the offset current source 54 to generate a predetermined offset potential 63 between the terminals of the load resistor RL1. When this offset potential 63 is generated, a noise margin is expanded, whereby even when a noise is superimposed on the transmission line of the strobing signal, the strobing comparator 51 hardly malfunctions. A current signal which is supplied from the base band unit 4 as a strobing signal cancels the above strobing offset current “lof” and is set higher than the threshold of the strobing comparator 51.

However, according to studies conducted by the inventors of the present invention, when the liquid crystal drive controller 10 is mounted on the glass substrate 70 as shown in FIG. 7 for serial transmission based on VESA standards shown in FIG. 5, it has been found that the influence of variations in wiring resistance on the glass substrate 70 is large. This will be described in detail hereinunder.

When the strobing offset current “lof” is supplied by the offset current source 54, the differential input potential difference “Vsc” of the strobing comparator is represented by the following equation.
Vsc=−lof×(R1+R2+100) (1)

The differential potential difference “Vstb” generated by the output current “Is” of the base band unit 4 is represented by the following equation.
Vstb=Is×100 (2)

When a potential obtained by adding the differential input potential difference “Vsc” of the strobing comparator generated by the strobing offset current “lof” to the differential potential difference “Vstb” generated by the output current “Is” of the base band unit 4 exceeds the offset potential difference “Vstbof” of the strobing comparator, a strobing signal is output to the output of the strobing comparator 51 from the base band unit 4. This is represented by the following expressions.
Vstb−Vsc=Is×100−lof×(R1+R2+100) (3)
(Is−lof)×100−lof×(R1+R2)>Vstbof (4)

When there is no wiring resistance on the glass substrate 70, that is, R1=R2=0, the above expression (4) becomes the following expression.
Vstb−Vsc=(Is−lof)×100>Vstbof (5)

The expression (4) includes a variable term (lof×(R1+R2)) as compared with the expression (5), thereby producing a shortage of margin. To eliminate this shortage of margin, the following methods (A) and (B) are conceivable.

(A) The number of input pads of the strobing comparator of the liquid crystal driver is increased to reduce resistances R1 and R2 so as to enable parallel wiring.

(B) “Is” and “lof” variations are suppressed so that operation is possible even when the variable term (lof×(R1+R2) is included in the expression (4).

However, in the case of the method (A), an increase in the number of pads for enabling parallel wiring may greatly increase the chip size of the liquid crystal drive controller 10. In the case of the method (B), the absolute value accuracy of the output current must be enhanced and a circuit for realizing this becomes complicated and large in scale inevitably, whereby the chip sizes of the base band unit 4 and the liquid crystal drive controller 10 may significantly increase.

It is an object of the present invention to provide a technology for eliminating a shortage of margin caused by wiring resistance without a great increase in the chip sizes.

The above and other objects and features of the present invention will become apparent from the following description when taken in conjunction with the accompanying drawings.

A brief description of typical ones of the inventions disclosed by the present application is given below.

That is, there is provided a liquid crystal drive controller including a strobing comparator for receiving a strobing signal indicative of the effectiveness of data transmitted over data transmission lines and a strobing offset current source for generating a predetermined offset potential in the input terminals of the strobing comparator by supplying a predetermined offset current to a load resistor provided in strobing transmission lines capable of transmitting the strobing signal, wherein the controller comprises first lines drawn from the input terminals of the strobing comparator, first external terminals capable of connecting the first lines to the strobing transmission lines, second lines drawn from the strobing offset current source, and second external terminals capable of connecting the second lines to the strobing transmission lines; and the first lines and the first external terminals, and the second lines and the second external terminals are electrically insulated from each other on the liquid crystal drive controller.

According to the above means, since the second lines and the second external terminals, and the first lines and the first external terminals are electrically insulated from each other, the first wires and the second wires are connected to the strobing terminals outside the liquid crystal drive controller, whereby the first wires are not included in the strobing offset current path of the strobing offset current source. Thereby, in the system including the above liquid crystal drive controller, a shortage of margin caused by wiring resistors on the transparent substrate can be eliminated.

There is also provided a liquid crystal drive controller comprising a data comparator for receiving data transmitted over the data transmission lines, third lines drawn from the input terminals of the data comparator, third external terminals capable of connecting the third lines to the data transmission lines, a data driver for outputting data to the outside, fourth lines drawn from the output terminals of the data driver, and fourth external terminals capable of connecting the fourth lines to the data transmission lines, wherein the third lines and the third external terminals, and the fourth lines and the fourth external terminals are electrically insulated from each other on the liquid crystal drive controller.

There is further provided a liquid crystal panel module comprising a transparent substrate on which a liquid crystal display unit capable of displaying information is formed and a liquid crystal drive unit capable of driving the liquid crystal display unit and mounted on the transparent substrate, wherein the above liquid crystal drive controller is used as the above liquid crystal drive unit.

Strobing terminals connected to the strobing transmission lines, first wires for connecting the strobing terminals and the first external terminals on the liquid crystal drive controller, and second wires for connecting the strobing terminals and the second external terminals on the liquid crystal drive controller not through the first wires are formed on the transparent substrate.

Strobing terminals connected to the strobing transmission lines, first wires for connecting the strobing terminals and the first external terminals on the liquid crystal drive controller, second wires for connecting the strobing terminals and the second external terminals on the liquid crystal drive controller not through the first wires, data terminals connected to the data transmission lines, third wires for connecting the data terminals and the third external terminals on the liquid crystal drive controller, and fourth wires for connecting the data terminals and the fourth external terminals on the liquid crystal drive controller not through the third wires are formed on the transparent substrate.

Further, strobing terminals connected to the strobing transmission lines, first wires for connecting the strobing terminals and the first external terminals on the liquid crystal drive controller, offset terminals connected to the strobing transmission lines outside the liquid crystal panel module, and second wires for connecting the offset terminals and the second external terminals on the liquid crystal drive controller not through the first wires can be formed on the transparent substrate.

There is still further provided a portable terminal system comprising the liquid crystal panel module constituted as described above.

An effect obtained by typical ones of the inventions disclosed by the present application is briefly described hereinbelow.

That is, a shortage of margin caused by wiring resistors can be eliminated without a great increase in the chip sizes.

### BRIEF DESCRIPTION OF THE DRAWINGS

FIG. 1 is a circuit diagram of the main section of a liquid crystal drive controller according to the present invention;

FIG. 2 is a block diagram showing the entire constitution of a portable telephone as an example of a portable terminal system including the above liquid crystal drive controller;

FIG. 3 is a block diagram showing the constitution of the main section of the above portable telephone;

FIG. 4 is a block diagram showing the entire constitution of the above liquid crystal drive controller;

FIG. 5 is a circuit diagram of an apparatus to be compared with the main section of the liquid crystal drive controller of the present invention;

FIG. 6 is a timing diagram of the main operation of the apparatus shown in FIG. 5;

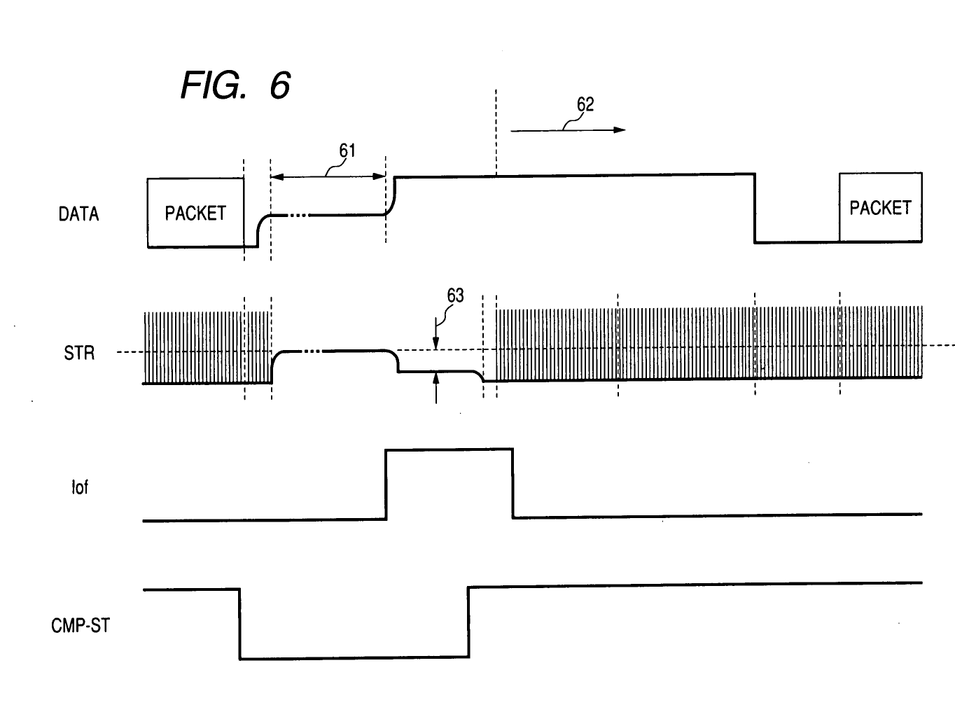

FIG. 7 is a circuit diagram of an apparatus to be compared of the main section of the liquid crystal drive controller of the present invention;

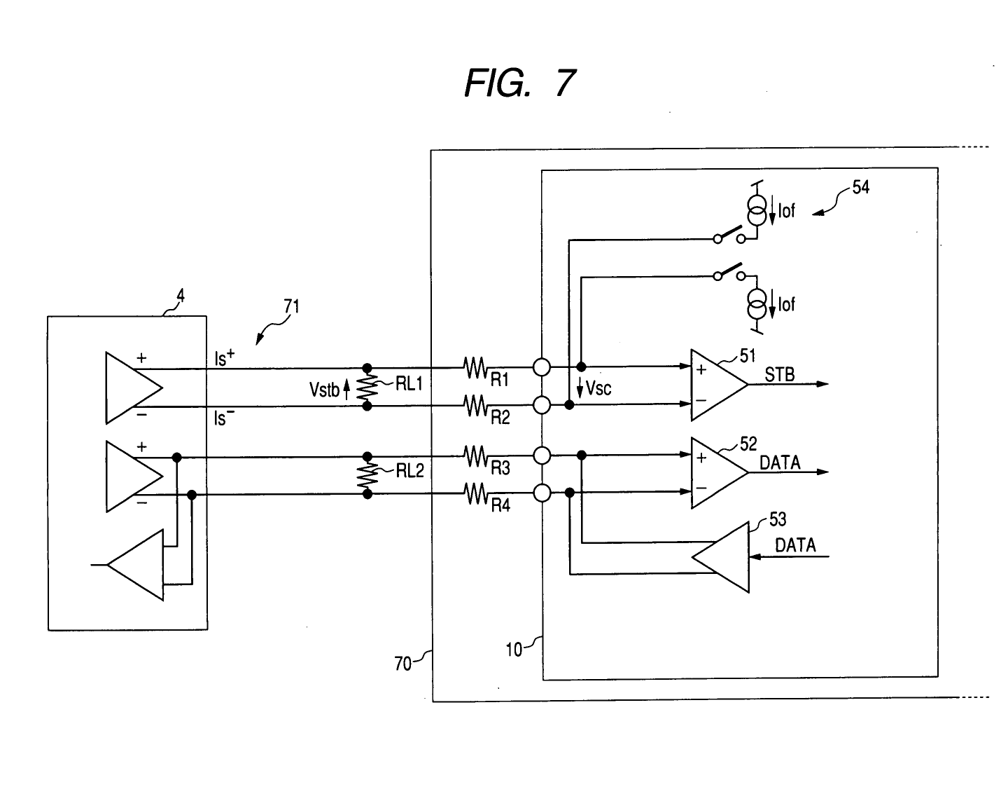

FIG. 8 is a circuit diagram showing the constitution of another main section in the liquid crystal drive controller of the present invention; and

FIG. 9 is a circuit diagram showing the constitution of still another main section in the liquid crystal drive controller of the present invention.

### DETAILED DESCRIPTION OF THE PREFERRED EMBODIMENTS

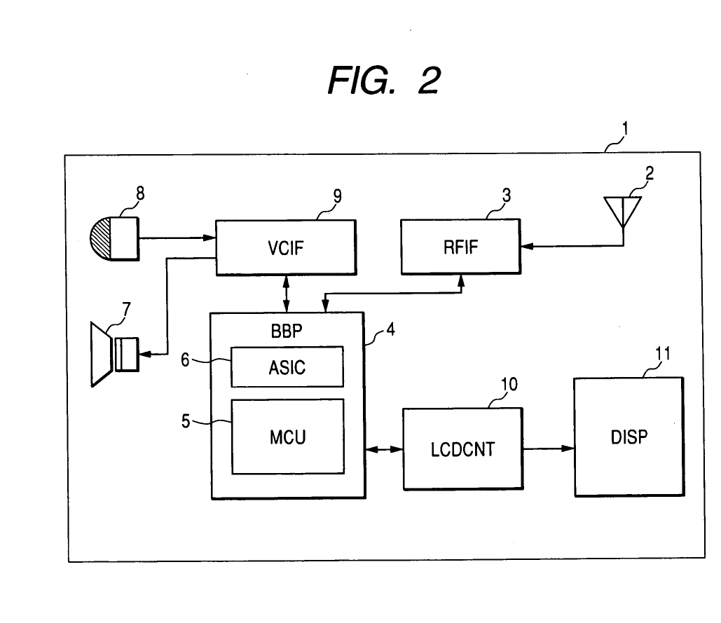

FIG. 2 shows a portable telephone as an example of a portable terminal system including the liquid crystal drive controller of the present invention. This portable telephone 1 is constituted as described below.

A received signal of a radio band received by an antenna 2 is transmitted to a high-frequency interface unit (RFIF) 3. The received signal is converted into a lower-frequency signal, demodulated and converted into a digital signal by the high-frequency interface unit 3 and then supplied to a base band unit (BBP) 4. The base band unit 4 uses a microcomputer (MCU) 5 to carry out channel codec processing so as to remove the secrecy of the received digital signal and correct an error. A semiconductor device for a specific purpose (ASIC) 6 is used to separate control data required for communication and communication data such as compressed voice data from each other. The control data is supplied to the MCU 5 which carries out communication protocol processing. The voice data taken out by channel codec processing is expanded by the MCU 5 and converted into an analog signal by an voice interface circuit (VCIF) 9 and reproduced as a voice by a speaker 7. As for transmission operation, a voice signal input from a microphone 8 is converted into a digital signal by the voice interface circuit 9, filtered by the MCU 5 and converted into compressed voice data. The ASIC 6 combines the compressed voice data and the control data from the MCU 5 to produce a transmission data sequence and the MCU 5 adds an error correction/detection signal and a secrecy code to the sequence to create transmission data. The transmission data is demodulated by the high-frequency interface unit 3, and the demodulated transmission data is converted into a high-frequency signal which is amplified and output from the antenna 2 as a radio signal.

The MCU 5 issues a display command and display data to the liquid crystal drive controller (LCDCNT) 10. Thereby, the liquid crystal drive controller 10 controls a liquid crystal display unit 11 to display an image. The MCU 5 comprises circuit units such as a central processing unit (CPU) and a digital signal processor (DSP). The MCU 5 may be divided into a base band processor in charge of base band processing for communication and an application processor in charge of additional function controls such as display control and security control. The LCDCNT 10, ASIC 6 and MCU 5 which are not particularly limited are each independently composed of a semiconductor device.

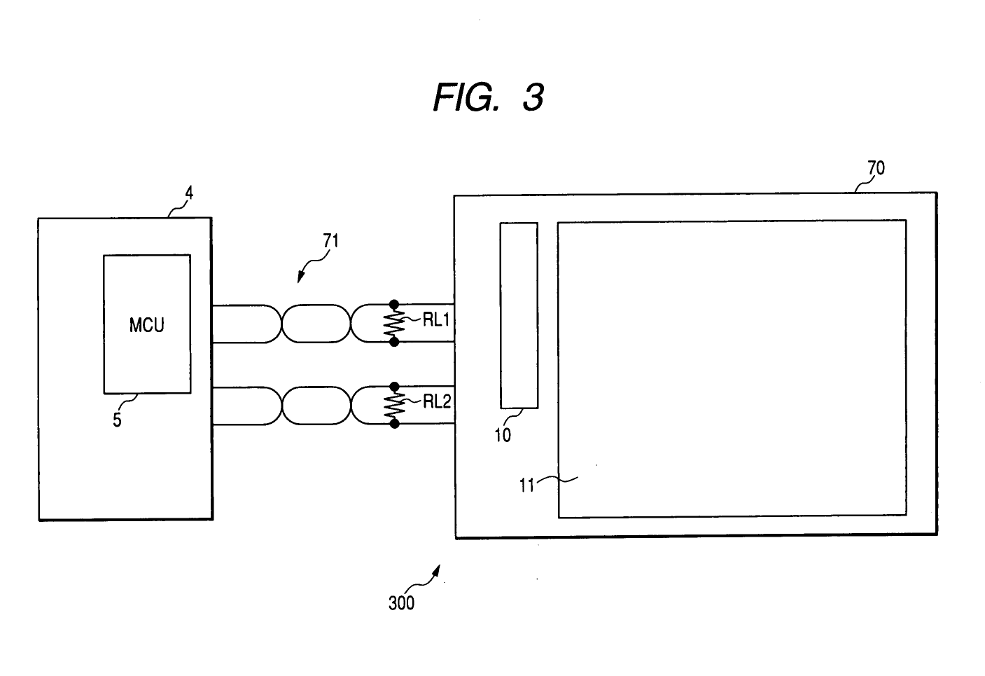

FIG. 3 shows the constitution of the main section of the above portable telephone 1.

The liquid crystal drive controller 10 and the liquid crystal display unit 11 are formed on a transparent substrate, for example, a glass substrate 70 to obtain a liquid crystal panel module 300. Wiring for connecting the liquid crystal drive controller 10 and the liquid crystal display unit 11 is composed of a transparent electrode film. The base band unit 4 and the glass substrate 70 are connected to each other by a printed wiring board 71 having flexibility. The transparent electrode film on the glass substrate 70 is made of ITO (Indium Tin Oxide) and the resistance value of the wiring is much larger than the resistance of wiring made of copper such as the printed wiring board 71.

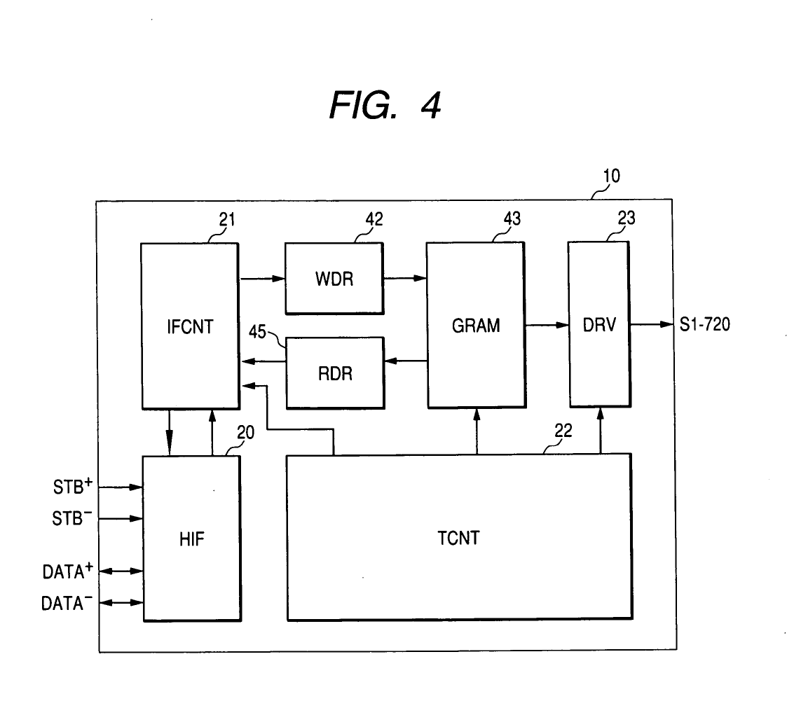

FIG. 4 shows an example of the above liquid crystal drive controller 10.

The base band unit 4 uses packets having a predetermined format to transmit commands and data to a host interface circuit 20. The host interface circuit 20 receives commands and display data from differential terminals DATA±. Strobing signals indicative of the effectiveness of the commands and display data are received from differential terminals STB±. An interface controller 21 controls the operation of the above host interface circuit 20, decodes a command address to generate a resistor selection signal and addresses a display memory (GRAM) 43 based on address information on a data packet. When an access instruction based on command data is a write operation to the display memory 43, the data of a data packet is supplied to a write data register (WDR) 42 over a bus 41 and stored in the display memory (GRAM) 43 at a proper timing. The storage of display data is carried out for each display frame unit. When the access instruction based on command data is a read operation from the display memory 43, data stored in the display memory 43 is read out to a read data register (RDR) 45 so that it can be supplied to a host device. When the command data register receives a display command, the display memory 43 carries out read operation in synchronism with a display timing. The control of read and display timings is conducted by a timing controller (TCNT) 22. Display data read from the display memory 43 in synchronism with a display timing is provided to a source driver (DRV) 23 through a latch circuit. The liquid crystal display unit 11 to be driven by the liquid crystal drive controller 10 is composed of a dot matrix type TFT (thin film transistor) liquid crystal panel and has a large number of source electrodes as signal electrodes and a large number of gate electrodes which are scanning electrodes as drive terminals. The liquid crystal display unit 11 is formed on a transparent substrate such as a glass substrate. The above liquid crystal drive controller 10 is mounted on this transparent substrate. The above liquid crystal display unit 11 and the above liquid crystal drive controller 10 are provided as a liquid crystal panel module. The source driver 23 drives the source electrodes of the liquid crystal display unit 11 by means of a drive terminal S1-720. The drive level of the drive terminal S1-720 is determined by using a predetermined gradient voltage.

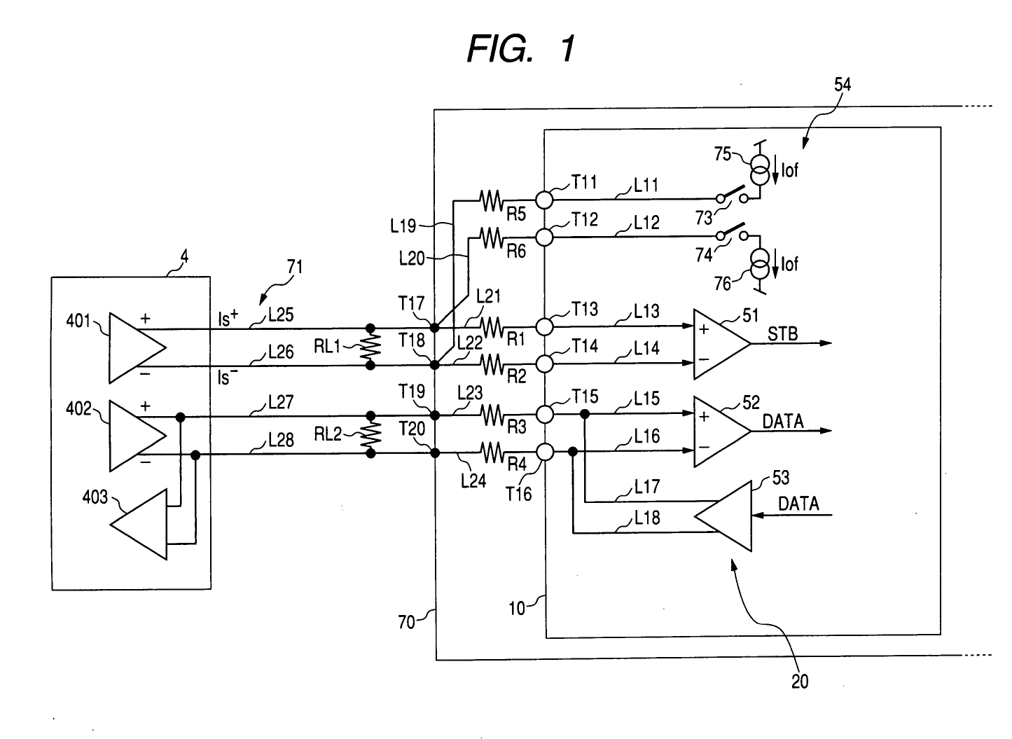

FIG. 1 shows an example of the host interface circuit 20 (see FIG. 4) in the above liquid crystal drive controller 10 and the connection state between the host interface circuit 20 and the base band unit 4.

The liquid crystal drive controller 10 is formed on one semiconductor substrate such as a monocrystal silicon substrate by a known semiconductor integrated circuit manufacturing technology and has first external terminals T13 and T14, second external terminals T11 and T12, and third external terminals T15 and T16. This liquid crystal drive controller 10 is mounted on a glass substrate 70 on which the liquid crystal display unit 11 (see FIG. 3) is formed. Strobing terminals T17 and T18 and data terminals T19 and T20 which can be electrically connected to the above liquid crystal drive controller 10 are provided on the glass substrate 70. The terminals T17 and T18 are connected to the differential output terminals of a strobing output buffer 401 in the base band unit 4 by strobing transmission lines L25 and L26, respectively. A load resistor (for example, 100Ω) RL1 is connected to the strobing transmission lines L25 and L26. The terminals T19 and T20 are connected to the differential output terminals of a data output buffer 402 and the differential input terminals of a data input buffer 403 in the base band unit 4 by data transmission lines L27 and L28, respectively. A load resistor (for example, 100Ω) RL2 is connected to the data transmission lines L27 and L28.

The host interface circuit 20 includes a strobing comparator 51, a data comparator 52, a data output buffer 53 and an offset current source 54. A strobing signal is transmitted to the liquid crystal drive controller 10 from the base band unit 4 and a data signal is transmitted in both ways between them. When a comparator activation signal CMP-ST is changed from a low level to a high level by the base band unit 4, the strobing comparator 51 and the data comparator 52 are activated. A current is differentially output from the base band unit 4, whereby the strobing comparator 51 detects a logic level (high level or low level) from a potential difference generated in the load resistor RL1 provided in the transmission lines to carry out signal transmission.

The strobing comparator 51 has two input terminals (+) and (−) for differential inputs. First lines L13 and L14 are drawn from the two input terminals (+) and (−) of this strobing comparator 51 and connected to the first external terminals T13 and T14, respectively. The first external terminals T13 and T14 are connected to the strobing terminals T17 and T18 by first wires L21 and L22, respectively.

The offset current source 54 includes constant current sources 75 and 76 and switches 73 and 74. When the switches 73 and 74 are turned on, a strobing offset current “lof” can be supplied from the constant current sources 75 and 76. Second lines L11 and L12 are drawn from the offset current source 54 and connected to the second external terminals T11 and T12, respectively. The second external terminals T11 and T12 are connected to the strobing terminals T17 and T18 by second wires L19 and L20, respectively. At this point, the above first lines L13 and L14 and the above first external terminals T13 and T14, and the above second lines L11 and L12 and the above external terminals T11 and T12 are electrically insulated from each other on the above liquid crystal drive controller 10, and the first lines L13 and L14 and the second lines L11 and L12 are connected to the strobing terminals T17 and T18, thereby making it possible to supply the strobing offset current “lof” to the load resistor RL1.

The data comparator 52 has two input terminals (+) and (−) for differential inputs. Third lines L15 and L16 are drawn from the two input terminals (+) and (−) of this data comparator 52 and connected to the third external terminals T15 and T16, respectively. The third external terminals T15 and T16 are connected to the data terminals T19 and T20 by third wires L23 and L24, respectively. Thereby, data output from the data output buffer 402 of the base band unit 4 can be input into the data comparator 52.

Fourth lines L17 and L18 are drawn from the differential output terminals of the data output buffer 53 and connected to the above third lines L15 and L16 in the liquid crystal drive controller 10, respectively.

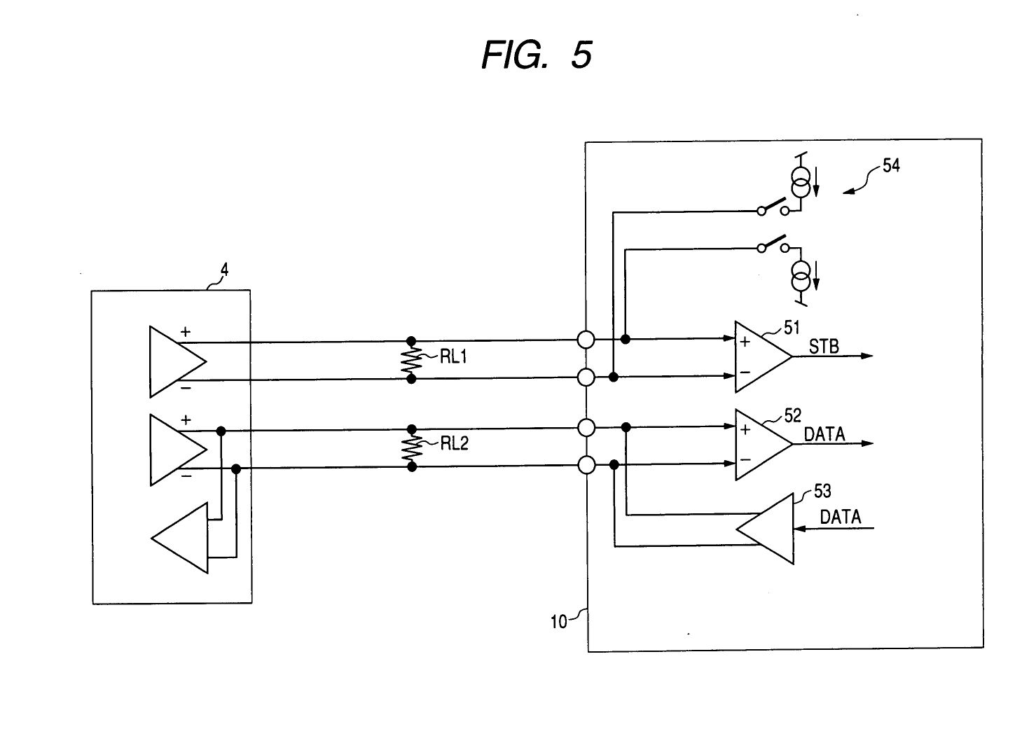

The basic operation of the above constitution is the same as that shown in FIG. 5. However, in this embodiment, a shortage of margin caused by wiring resistors on the glass substrate 70 is canceled as described below.

Since the first wires L21 and L22, the second wires L19 and L20, and the third wires L23 and L24 are composed of the transparent electrode layer of the glass substrate 70, the values of their wiring resistors R1 to R6 are much larger than those of wires formed on a printed wiring board 71 having flexibility, such as the strobing transmission lines L25 and L26 and the data transmission lines L27 and L28. However, the above first lines L13 and L14 and the above first external terminals T13 and T14, and the above second lines L11 and L12 and the above second external terminals T11 and T12 are electrically insulated from each other on the above liquid crystal drive controller 10, and the first lines L13 and L14 and the second lines L11 and L12 are connected to the strobing terminals T17 and T18, thereby making it possible to supply a strobing offset current “lof” to the load resistor RL1. Therefore, the first wires L21 and L22 are not included in the current path of the strobing offset current “lof” from the strobing offset current source 54. That is, the strobing offset current “lof” does not run through the wiring resistors R1 and R2. Therefore, in the above expression (4), the variable term (lof×(R1+R2)) becomes “0” and the expression (4) becomes equivalent to the above expression (5) in which there are no wiring resistors R1 and R2. Consequently, according to the constitution shown in FIG. 1, a shortage of margin caused by wiring resistors R1 and R2 on the glass substrate 70 can be eliminated. In addition, according to the constitution shown in FIG. 1, although the second external terminals T11 and T12 are newly added, an increase in the number of external terminals can be minimized as compared with a case where the wiring resistances of the wiring resistors R1 and R2 are reduced by providing a large number of the first external terminals T13 and T14 and connecting a large number of the first wires L21 and L22 in parallel corresponding to the first external terminals. Therefore, the chip size of the liquid crystal drive controller 10 does not greatly increase.

The following function and effect can be obtained according to the above embodiment.

Since the second lines L11 and L12 and the second external terminals T11 and T12, and the first lines L13 and L14 and the first external terminals T13 and T14 are electrically insulated from each other, by connecting the first lines L13 and L14 and the second lines L11 and L12 to the strobing terminals T17 and T18 outside the liquid crystal drive controller 10, the first wires L21 and L22 cannot be included in the current path of the strobing offset current “lof” from the strobing offset current source 54. Thereby, in the system including the above liquid crystal drive controller 10, a shortage of margin caused by the wiring resistors R1 and R2 on the glass substrate 70 can be eliminated.

Having described the invention made by the inventors of the present invention as related to the embodiment shown in the accompanying drawings, it is needless to say that the present invention is not limited thereto and that various changes and modifications may be made in the invention without departing from the spirit and scope thereof.

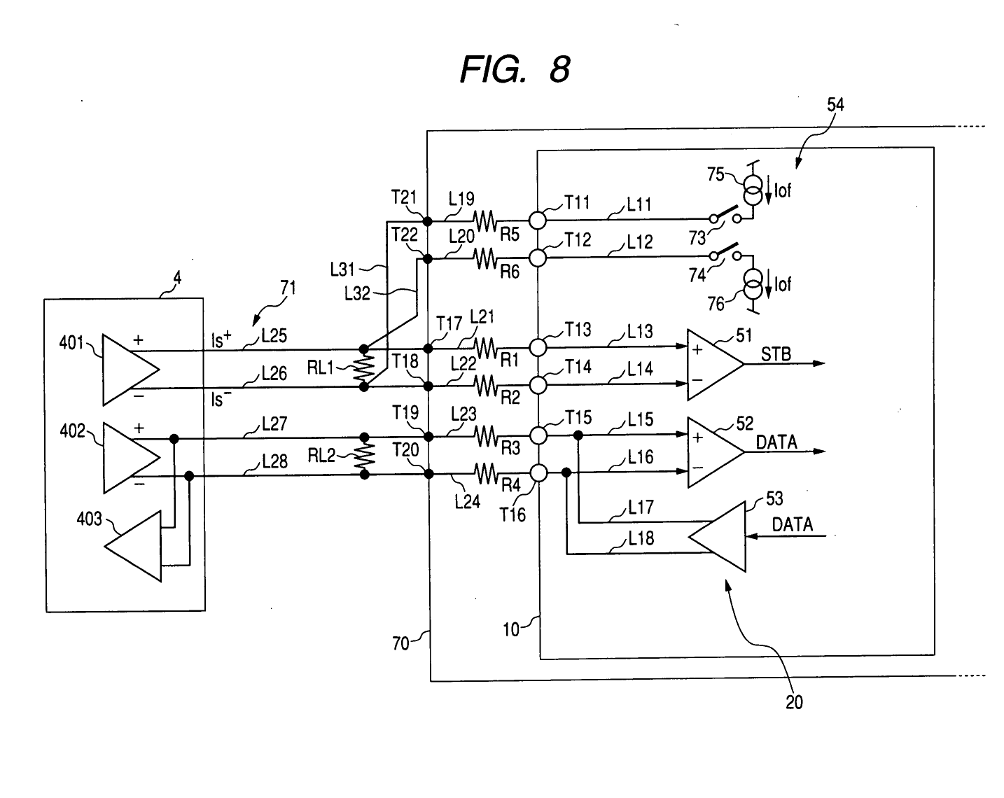

For example, as shown in FIG. 8, strobing offset current terminals T21 and T22 are provided on the glass substrate 70 and connected to the second wires L19 and L20. The strobing offset current “lof” may be supplied to the load resistor RL1 from the strobing offset current terminals T21 and T22 over strobing offset current transmission lines L31 and L32. In this case, the same function and effect as in FIG. 1 can be obtained.

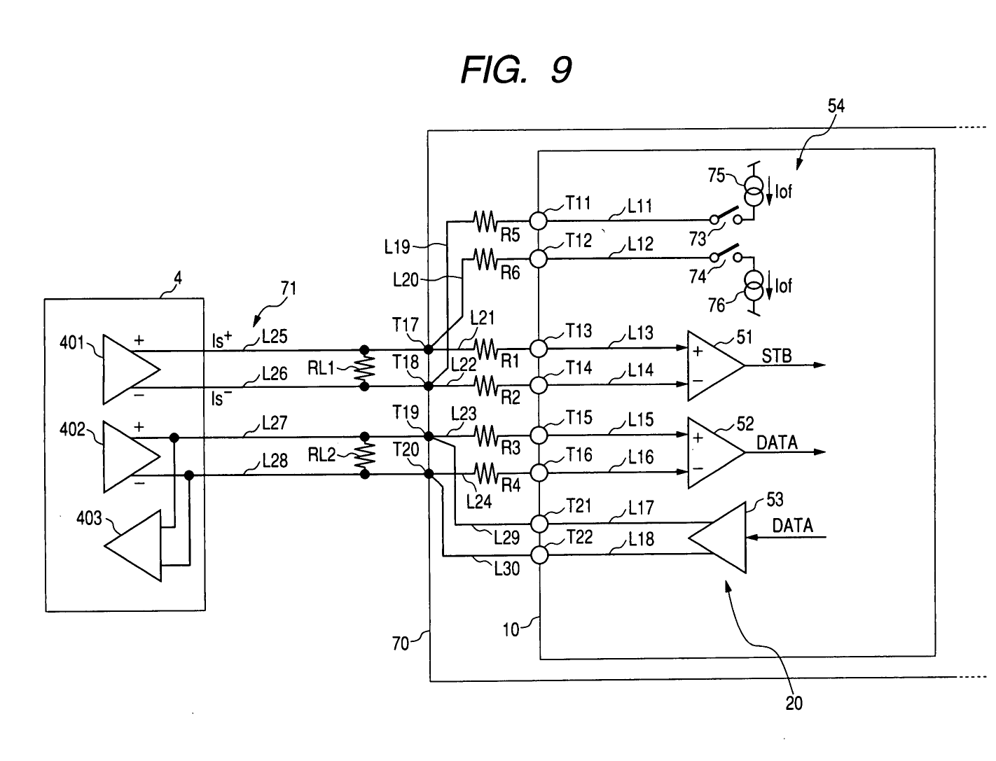

As shown in FIG. 9, wires on the output terminal side of the data output buffer 53 are aligned with the wires of the strobing offset current source, whereby a delay condition for a signal can be provided. That is, fourth external terminals T21 and T22 are provided on the liquid crystal drive controller 10 and the fourth lines are connected to the fourth external terminals T21 and T22, respectively. The above fourth external terminals T21 and T22 are connected to the data terminals T19 and T20 by the fourth wires L29 and L30, respectively. Since the fourth wires L29 and L30 have wiring resistors R7 and R8 corresponding to the wiring resistors R5 and R6 in the above second wires L19 and L20, skews can be aligned by strobing signal-related wires and data-related wires, thereby making it possible to reduce the number of signal transmission mistakes.

In the above description, the invention made by the inventors of the present invention is applied to a portable telephone which is the application field of the invention. The present invention is not limited to this and can be widely applied to portable terminal systems.

The present invention can be applied based on the condition that a liquid crystal display unit is driven based on at least data.

1. A liquid crystal drive controller comprising:
a strobing comparator for receiving a strobing signal indicative of effectiveness of data transmitted over data transmission lines; and
a strobing offset current source for generating a predetermined offset potential in input terminals of the strobing comparator by supplying a predetermined offset current to a load resistor provided in strobing transmission lines capable of transmitting the strobe signal;
first lines coupled to the input terminals of the strobing comparator;
first external terminals capable of connecting the first lines to the strobing transmission lines;
second lines coupled to the strobing offset current source; and
second external terminals capable of connecting the second lines to the strobing transmission lines,
wherein the first lines and the first external terminals, and the second lines and the second external terminals are electrically insulated from each other on the liquid crystal drive controller.

2. The liquid crystal drive controller according to claim 1, comprising:
a data comparator for receiving data transmitted over the data transmission lines;
third lines coupled to the input terminals of the data comparator;
third external terminals capable of connecting the third lines to the data transmission lines;
a data driver for outputting data to the outside;
fourth lines coupled to the output terminals of the data driver; and
fourth external terminals capable of connecting the fourth lines to the data transmission lines,
wherein the third lines and the third external terminals, and the fourth lines and the fourth external terminals are electrically insulated from each other on the liquid crystal drive controller.

3. A liquid crystal panel module comprising:
a transparent substrate on which a liquid crystal display unit capable of displaying information is formed; and
a liquid crystal drive unit capable of driving the liquid crystal display unit and mounted on the transparent substrate,
wherein the liquid crystal drive unit is the liquid crystal drive controller according to claim 1.

4. The liquid crystal panel module according to claim 3, having formed on the transparent substrate thereof:
strobing terminals connected to the strobing transmission lines;
first wires for connecting the strobing terminals and the first external terminals on the liquid crystal drive controller; and
second wires for connecting the strobing terminals and the second external terminals on the liquid crystal drive controller not through the first wires.

5. The liquid crystal panel module according to claim 3, having formed on the transparent substrate thereof:
strobing terminals connected to the strobing transmission lines;
first wires for connecting the strobing terminals and the first external terminals on the liquid crystal drive controller;
second wires for connecting the strobing terminals and the second external terminals on the liquid crystal drive controller not through the first wires;
data terminals connected to the data transmission lines;
third wires for connecting the data terminals and the third external terminals on the liquid crystal drive controller; and
fourth wires for connecting the data terminals and the fourth external terminals on the liquid crystal drive controller not through the third wires.

6. The liquid crystal panel module according to claim 3, having formed on the transparent substrate thereof:
strobing terminals connected to the strobing transmission lines;
first wires for connecting the strobing terminals and the first external terminals on the liquid crystal drive controller;
offset terminals connected to the strobing transmission lines outside the liquid crystal panel module; and
second wires for connecting the offset terminals and the second external terminals on the liquid crystal drive controller not through the first wires.

7. A portable terminal system comprising the liquid crystal panel module of claim 3, which is supported by a housing.

8. A portable terminal system comprising the liquid crystal panel module of claim 4, which is supported by a housing.

9. A portable terminal system comprising the liquid crystal panel module of claim 5, which is supported by a housing.

10. A portable terminal system comprising the liquid crystal panel module of claim 6, which is supported by a housing.
